(19) United States
(12) Patent Application Publication
(10) Pub. No.: US 2025/0178984 A1
(43) Pub. Date: Jun. 5, 2025

(54) Scented Soil Additive In Dissolving Carrier

(71) Applicant: Andrew Graff, Laguna Beach, CA (US)

(72) Inventor: Andrew Graff, Laguna Beach, CA (US)

(21) Appl. No.: 19/046,236

(22) Filed: Feb. 5, 2025

Related U.S. Application Data
(63) Continuation-in-part of application No. 18/505,717, filed on Nov. 9, 2023.

(51) Int. Cl. C05G 5/35; C05C 7/00; C05D 9/00; C05F 11/00; C05G 5/14

(52) U.S. Cl. CPC C05G 5/35; C05C 7/00; C05D 9/00; C05F 11/00; C05G 5/14

(57) ABSTRACT

A composition of matter comprising a plant-usable nutrient derived from a first source, an odiferous compound obtained from a second source different from the first source; and a water-dissolvable carrier that carries the plant-usable nutrient and the odiferous compound.

This application is a continuation-in-part and claims the benefit and priority to U.S. patent application Ser. No. 18/505,717, filed on Nov. 11, 2023, which claims the benefit of priority to U.S. Provisional Patent Application No. 63/424,206, filed on Nov. 10 2022, each of which is incorporated herein by reference in its entirety.

### FIELD OF THE INVENTION

The field of the invention is plant fertilizers.

### Background

The background description includes information that may be useful in understanding the present invention. It is not an admission that any of the information provided herein is prior art or relevant to the presently claimed invention, or that any publication specifically or implicitly referenced is prior art.

Plant fertilizers, especially those from natural sources such as guano, large animal dung or other animal wastes can have an undesirable odor. The odor can be especially problematic when used on indoor plants.

GrowScripts™ markets a leaf spray advertised as combining a plant supplement with a desirable smelling odorant. See http://www.growscripts.com/burst-scented-plant-food-nutrition/#. However, such leaf sprays would necessarily be short-acting, and would likely deliver only small amounts of nitrogen, phosphorus, or other plant nutrients to the soil.

The GrowScripts reference, and all other publications discussed herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

What is still needed is a water-dissolvable carrier that can be inserted into the soil, that would provide both significant amounts of plant nutrients, as well as contributing a desirable odor to the environment.

The following description includes information that may be useful in understanding the present invention. It is not an admission that any of the information provided herein is prior art or relevant to the presently claimed invention, or that any publication specifically or implicitly referenced is prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a water-dissolvable carrier is used to distribute a plant-usable nutrient derived from a first source, and an odiferous compound obtained from a second source different from the first source.

The first source can advantageously be selected from the group comprising an animal excrement, an animal shell, a ground shell of a plant, and seaweed. For example, the source of the plant-usable nutrient can be guano, egg shell, coffee grounds, or seaweed.

The odiferous compound preferably comprises an essential oil of a culinary herb, for example thyme, clove, rosemary, lavender, yarrow, basil, and peppermint.

Odiferous compound includes those providing a pleasant fragrance or a fragrance containing one or more precursors/profragrances. For example, the odiferous compound includes a combination of a fragrance oil and a microencapsulated fragrance oil.

The carrier can have any suitable shape, including for example, a stick, bead or tablet. Contemplated carriers include one or more water-dissolvable polymers, for example, poly (hydroxypropyl methacrylate), poly (l-lysine), poly (aspartic acid), poly (vinylpyrrolidone), poly (N-vinyl-2-pyrrolidone-co-vinylamide), and poly (styrene co-maleic acid/anhydride). Especially preferred water-dissolvable polymers include hydrolyzed collagen and dissolvable seaweed powder.

Further, the carrier includes a water-dissolvable polymer having one of (a) a calcium-crosslinked coacervated bead composed of sodium alginate or alginic acid and chitosan, (b) a tripoly-phosphate-crosslinked coacervated bead composed of sodium alginate or alginic acid and chitosan, (c) a mixture of calcium-and tripoly-phosphate-crosslinked coacervated bead composed of sodium alginate or alginic acid and chitosan, (d) a calcium-crosslinked coacervated bead composed of sodium alginate or alginic acid and protein or hydrolyzed protein, (e) a tripoly-phosphate-crosslinked coacervated bead composed of sodium alginate or alginic acid and protein or hydrolyzed protein, and (f) a mixture of calcium-and tripoly-phosphate-crosslinked coacervated bead composed of sodium alginate or alginic acid and protein or hydrolyzed protein.

The protein or hydrolyzed protein is based on pea protein, gelatin, collagen, silk protein or other proteins, and mixtures thereof.

The sodium alginate or alginic acid is replaced by another natively charged polysaccharides such as sodium carboxy methyl cellulose, carrageenan, pectin, xanthan gum, and gum arabic.

Carriers can advantageously comprise a compressed multi-component powder.

Shaped carriers include an additional chitosan or protein coating, or are blended with a flow agent like starch or silica and subsequently dried.

The chitosan typically has a molecular weight from about 50,000 to 500,000 Daltons.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic showing production of fragrance-loaded alginate beads made with alginate-chitosan blend, with and without Ca++ crosslinking, using Tween 40 or Tween 20 as emulsifier.

FIG. 2 is a schematic showing production of fragrance-loaded alginate beads made with alginate-chitosan blend, with and without Ca++ crosslinking, using capsul chemically modified food starch as emulsifier.

FIG. 3 is a schematic showing production of fragrance-loaded alginate beads made with alginate-chitosan blend, with and without Tripolyphosphate crosslinking, using Tween 40 or Tween 20 as emulsifier.

FIG. 4 is a schematic showing production of fragrance-loaded alginate beads made with alginate-chitosan blend, with and without Tripolyphosphate crosslinking, using capsul chemically modified food starch as emulsifier.

FIG. 5 is a schematic showing production of essential oil-loaded alginate beads.

FIG. 6 is a schematic showing production of essential oil-loaded alginate beads and coat/mix with chitosan and dry, post-crosslinked with Ca++ or Tripolyphosphate.

FIG. 7 is a schematic showing production of essential oil-loaded alginate beads and coat/mix with protein (i.e. pea protein) and dry.

FIG. 8 is a schematic showing production of essential oil emulsion, stabilized by food starch and sodium alginate, optionally post-crosslinked with Ca++ or Tripolyphosphate.

FIG. 9 is a schematic showing production of essential oil-loaded alginate beads and coat/mix with protein (i.e. pea protein) and dry, post-crosslinked with Ca++ or Tripolyphosphate.

FIG. 10 is a schematic showing a process for deacetylation conversion of chitin to chitosan.

FIG. 11 is a schematic showing a process for encapsulation by complex coacervation.

FIG. 12 is a schematic showing a process for encapsulation using starch spray-drying.

FIG. 13 is a schematic showing a process for moisture-activated release from starch spray-dried powder.

FIG. 14 is a schematic showing contemplated interaction of sodium alginate with calcium ions.

FIG. 15 depicts beads of the inventive subject matter.

FIG. 16 depicts further beads of the inventive subject matter.

FIG. 17 depicts example beads of the inventive subject matter.

### DETAILED DESCRIPTION

Preferred embodiments include fertilizers that break down and release a pleasant scent when watered. The scents can have dual purposes, such as a feline and bug repellant. It is contemplated that some consumers don't have house plants because their felines tend to play with and/or destroy their house plants, and products as discussed herein could help with that situation. In short, contemplated products can offer consumers a simple pleasure of a nice smell filling one's living space, without requiring a flame as would be necessitated by a burning candle.

Contemplated substances that can be used to provide the desirable odors in essential oils of thyme, clove, rosemary, lavender, yarrow, basil oil, and peppermint, or other culinary herbs. These substances are also considered advantageous for the plants. Using essential oils helps in the prevention of animals and pests, while encouraging plants' growth.

Contemplated form factors for the carriers include beads, sticks, funnels, and powders. Sticks can have different sizes depending on the plant/planter sizes. A biodegradable funnel could contain beads or other bulk nutrients. funnel. The funnel spike' can advantageously break down when poured over with water. The beads can go into the funnel spike to release the smell. Once the spike dissolves, a consumer could buy and install a new spike'.

Three tiers of desirable smells can be characterized as follows:
1) Affordable “clean” smell. This could be used for hotels/malls/nursing homes.
2) “Sophisticated”—for example “Santal 33™”
3) Neutral or minimal scent. Just to clean the space/pet/pest repellent.

The base of the product could be polyphosphate beads infused with the other ingredients and oils. Another option would be calcium condensed and infused with the ingredients/oils. As the water interacts with the calcium, I think this could disperse the smell further.

Egg shells and coffee grounds could be obtained from local restaurants as a way to boast their “eco friendly” goals.

Seaweed is a broad spectrum fertilizer that is rich in beneficial trace minerals and hormones that stimulate plant growth. Seaweed is high in carbohydrates which are essential building blocks in growing plants, and low in cellulose so it breaks down readily.

In some embodiments the odiferous compound includes a pleasant fragrance or fragrance containing one or more precursors/profragrances. For example the odiferous compound includes a combination of a fragrance oil and a microencapsulated fragrance oil.

The carrier typically includes a water-dissolvable polymer, a calcium-crosslinked coacervated bead composed of sodium alginate or alginic acid and chitosan, or combinations thereof. The carrier can include a water-dissolvable polymer having a tripoly-phosphate-crosslinked coacervated bead composed of sodium alginate or alginic acid and chitosan. The carrier can also include a water-dissolvable polymer having a mixture of calcium-and tripoly-phosphate-crosslinked coacervated bead composed of sodium alginate or alginic acid and chitosan. In some embodiments the carrier includes a water-dissolvable polymer having a calcium-crosslinked coacervated bead composed of sodium alginate or alginic acid and protein or hydrolyzed protein. Further, the carrier can include a water-dissolvable polymer having a tripoly-phosphate-crosslinked coacervated bead composed of sodium alginate or alginic acid and protein or hydrolyzed protein.

The carrier can also include a water-dissolvable polymer with a mixture of calcium-and tripoly-phosphate-crosslinked coacervated bead composed of sodium alginate or alginic acid and protein or hydrolyzed protein. For example, the protein or hydrolyzed protein discussed above can be based on pea protein, gelatin, collagen, silk protein or other proteins, and mixtures thereof. The sodium alginate or alginic acid discussed above can also be replaced by other natively charged polysaccharides such as sodium carboxy methyl cellulose, carrageenan, pectin, xanthan gum, and gum arabic.

In some embodiments the carrier has the shape of a stick, a bead, or a tablet. Further, the shaped carrier can include an additional chitosan or protein coating, or combinations thereof. The shaped carrier can also be blended with a flow agent like starch or silica and subsequently dried. In some embodiments, the chitosan referenced above has a molecular weight from about 50,000 to 500,000 Daltons.

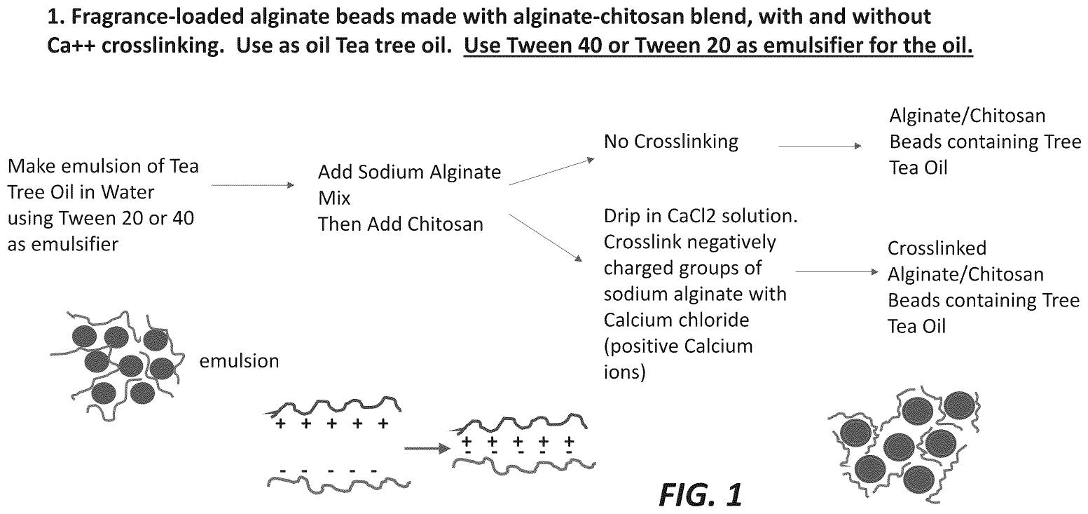

Experimentation was performed to produce samples of the claimed substances. Various methods and results are shown in FIGS. 1-22, as described below.

FIG. 1 is a schematic showing production of fragrance-loaded alginate beads made with alginate-chitosan blend, with and without Ca++ crosslinking, using Tween 40 or Tween 20 as emulsifier.

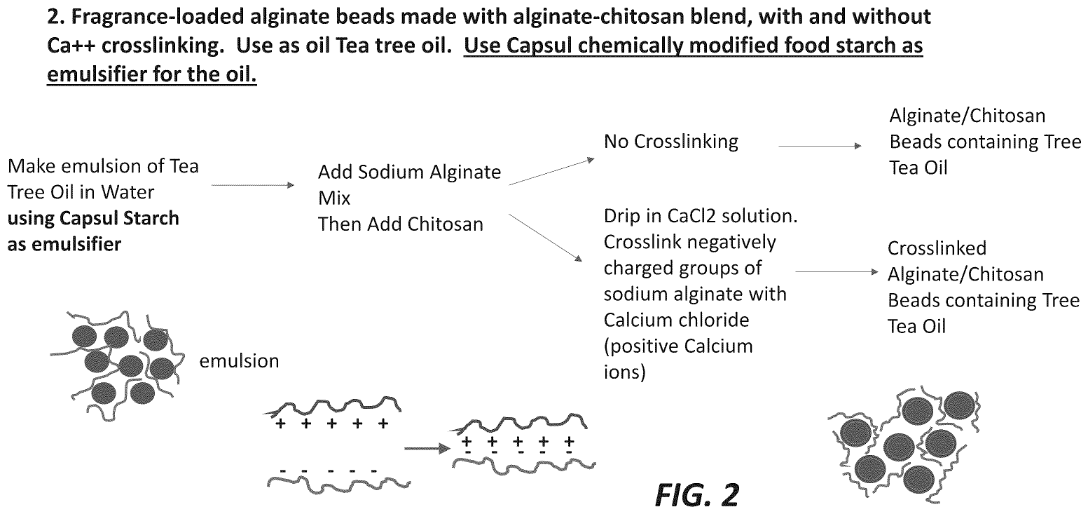

FIG. 2 is a schematic showing production of fragrance-loaded alginate beads made with alginate-chitosan blend, with and without Ca++ crosslinking, using capsul chemically modified food starch as emulsifier.

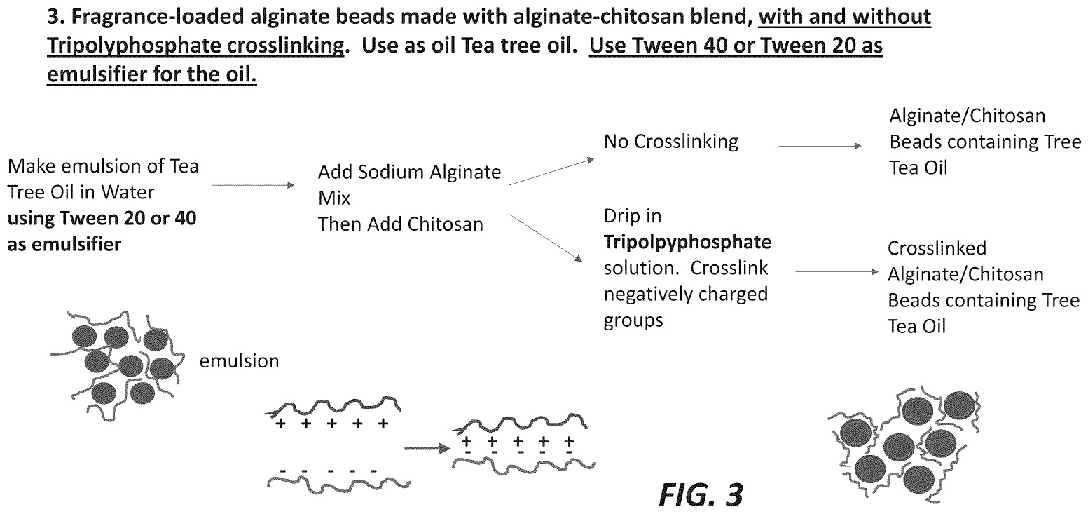

FIG. 3 is a schematic showing production of fragrance-loaded alginate beads made with alginate-chitosan blend, with and without Tripolyphosphate crosslinking, using Tween 40 or Tween 20 as emulsifier.

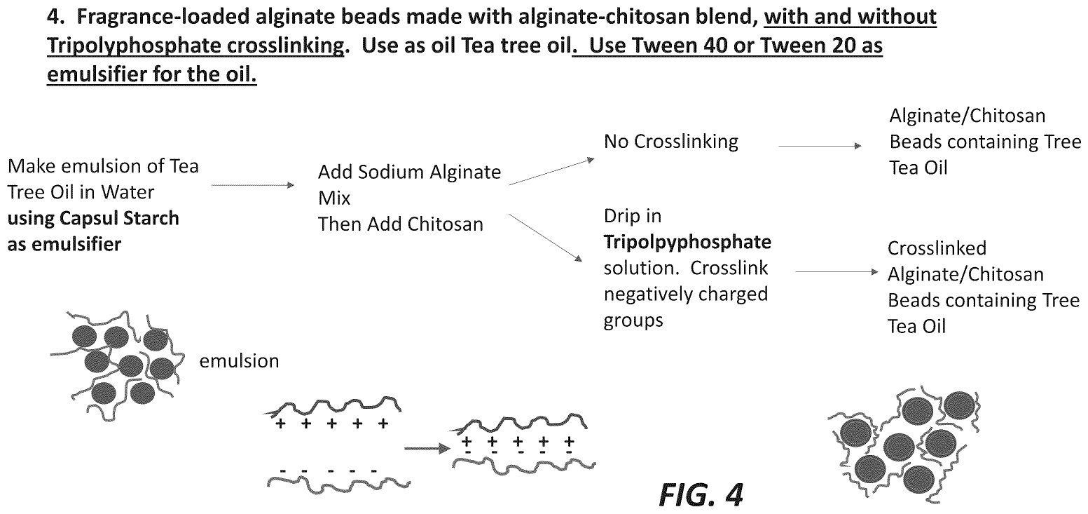

FIG. 4 is a schematic showing production of fragrance-loaded alginate beads made with alginate-chitosan blend, with and without Tripolyphosphate crosslinking, using capsul chemically modified food starch as emulsifier.

Contemplated non-layered options include the following:
1. Fragrance-loaded alginate beads made with alginate-chitosan blend, with and without Ca++ crosslinking. Use as oil Tea tree oil. Use Tween 40 or Tween 20 as emulsifier for the oil.
2. Fragrance-loaded alginate beads made with alginate-chitosan blend, with and without Ca++ crosslinking. Use as oil Tea tree oil. Use Capsul chemically modified food starch as emulsifier for the oil.
3. Fragrance-loaded alginate beads made with alginate-chitosan blend, with and without Tripolyphosphate crosslinking. Use as oil Tea tree oil. Use Tween 40 or Tween 20 as emulsifier for the oil.
4. Fragrance-loaded alginate beads made with alginate-chitosan blend, with and without Tripolyphosphate crosslinking. Use as oil Tea tree oil. Use Capsul chemically modified food starch as emulsifier for the oil.
5. In 3, 4, 5, and 6 vary degree of crosslinking to create the desired release profile (perhaps initially explored by swelling of a cast film)
6. Encapsulation of oil in Ca-alginate capsules using an inverse gelation technique

Contemplated layer options include the following:
1. Essential oil-loaded alginate beads and coat/mix with chitosan and dry
2. Essential oil-loaded alginate beads and coat/mix with chitosan and dry, post-crosslinked with Ca++ or Tripolyphosphate
3. Essential oil-loaded alginate beads and coat/mix with protein (i.e. pea protein) and dry
4. Essential oil-loaded alginate beads and coat/mix with protein (i.e. pea protein) and dry, post-crosslinked with Ca++ or Tripolyphosphate
5. Essential oil emulsion, stabilized by food starch and sodium alginate, form beads and then mix with chitosan or protein (i.e. pea protein), optionally post-crosslinked with Ca++ or Tripolyphosphate
6. Initial film exploration: Explore layered films and their release/swelling profile. Initial test: in petrie dish, place solution of alginate and chitosan with various levels of Ca++, let dry and then study dissolving/swelling in water. See article “pH_responsive_chitosan_alginate_polyelec.pdf”.

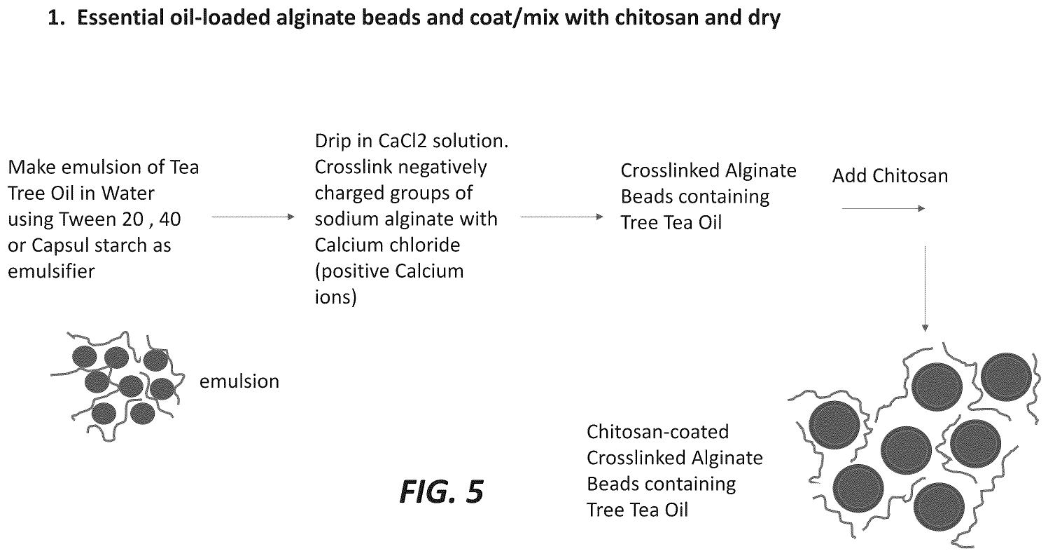

FIG. 5 is a schematic showing production of essential oil-loaded alginate beads.

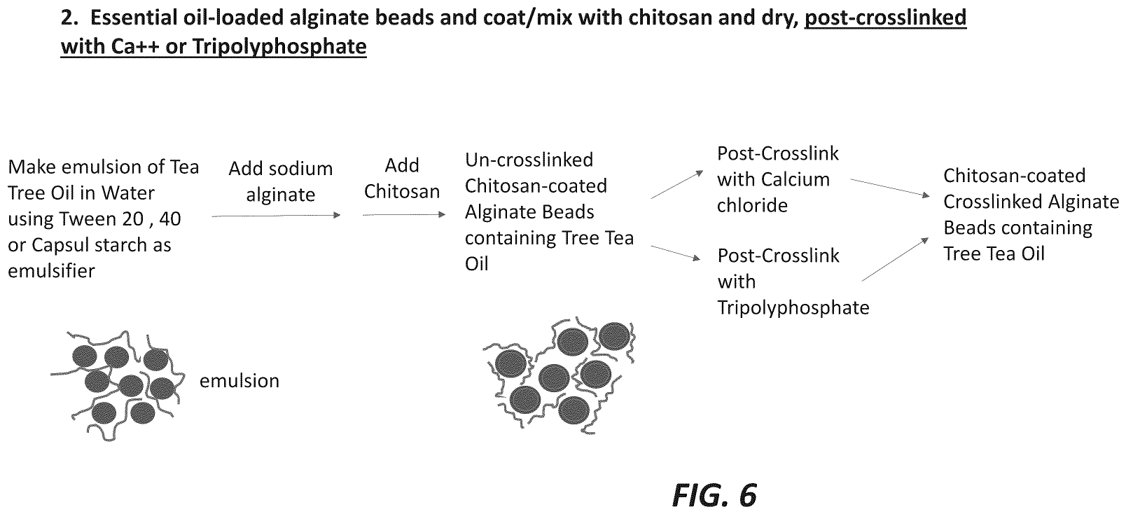

FIG. 6 is a schematic showing production of essential oil-loaded alginate beads and coat/mix with chitosan and dry, post-crosslinked with Ca++ or Tripolyphosphate.

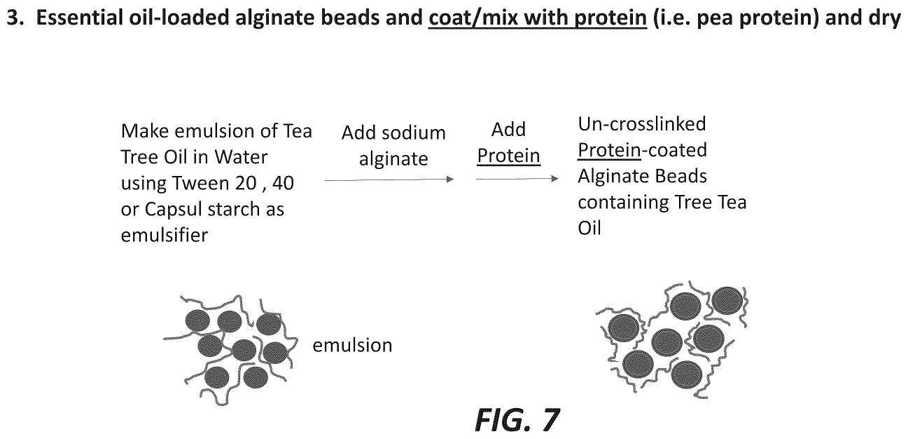

FIG. 7 is a schematic showing production of essential oil-loaded alginate beads and coat/mix with protein (i.e. pea protein) and dry.

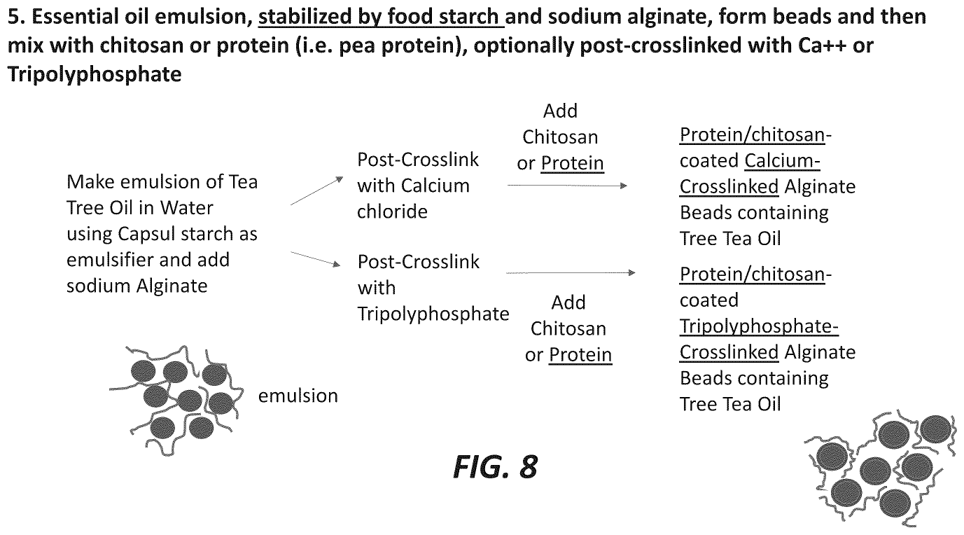

FIG. 8 is a schematic showing production of essential oil emulsion, stabilized by food starch and sodium alginate, optionally post-crosslinked with Ca++ or Tripolyphosphate.

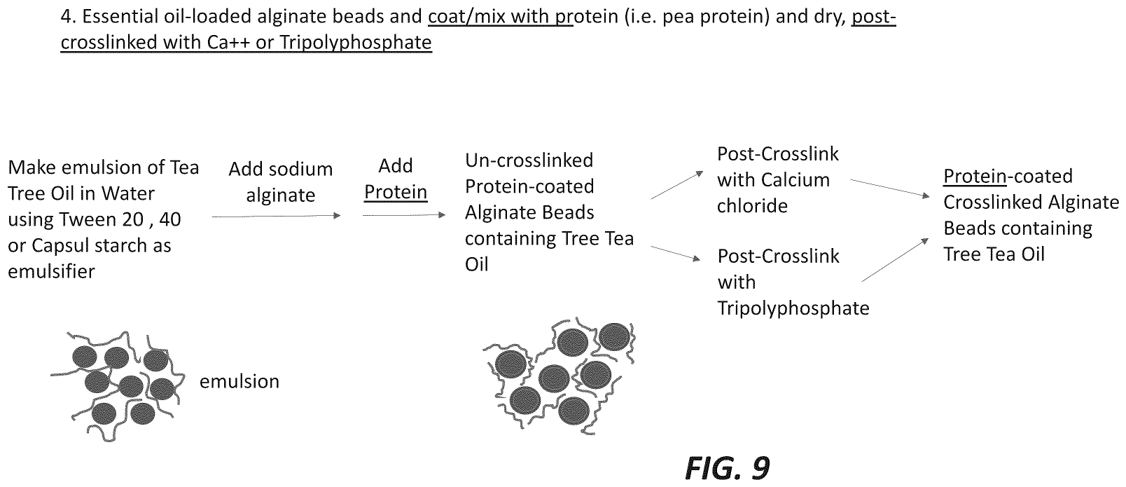

FIG. 9 is a schematic showing production of essential oil-loaded alginate beads and coat/mix with protein (i.e. pea protein) and dry, post-crosslinked with Ca++ or Tripolyphosphate.

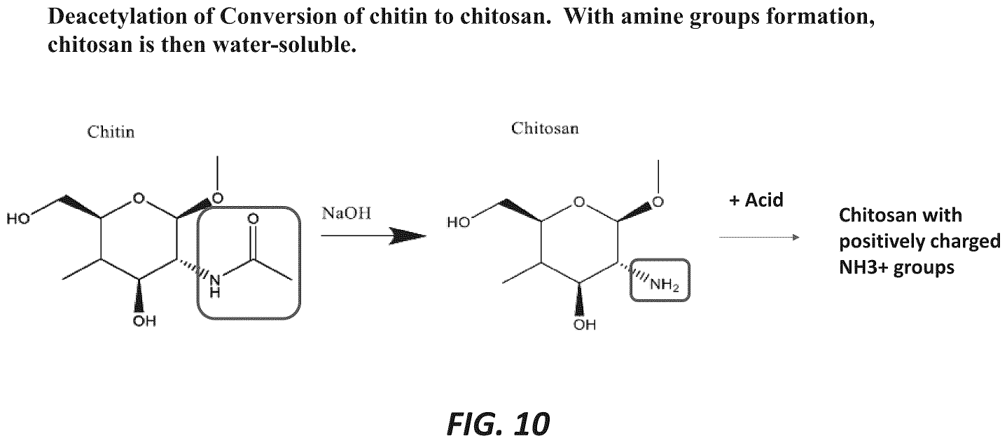

FIG. 10 is a schematic showing a process for deacetylation conversion of chitin to chitosan.

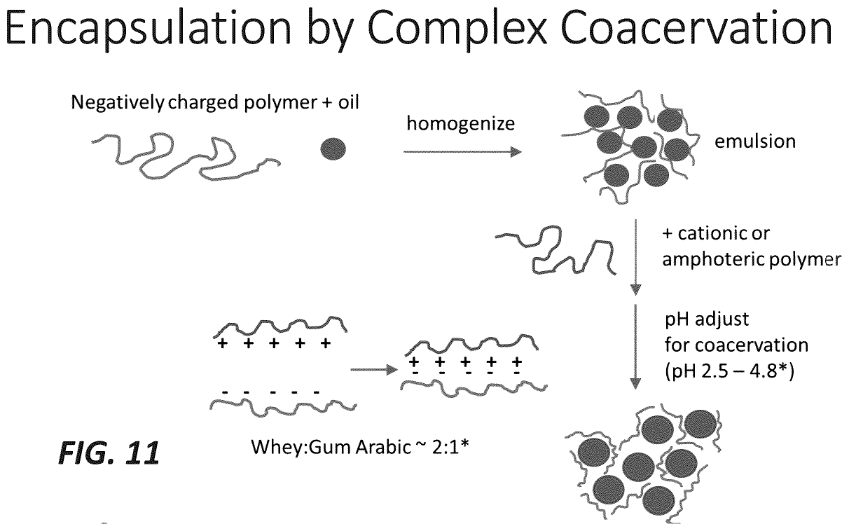

FIG. 11 is a schematic showing a process for encapsulation by complex coacervation.

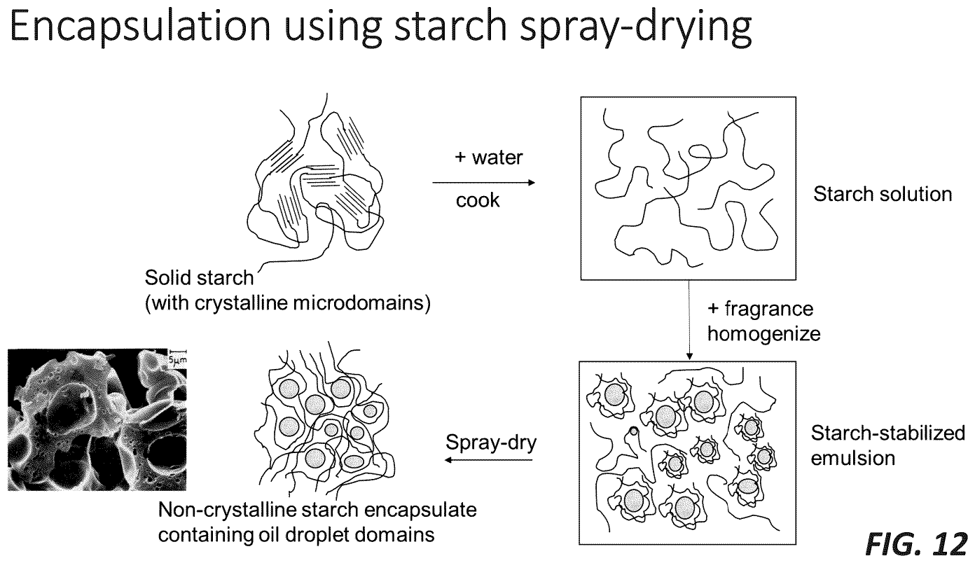

FIG. 12 is a schematic showing a process for encapsulation using starch spray-drying.

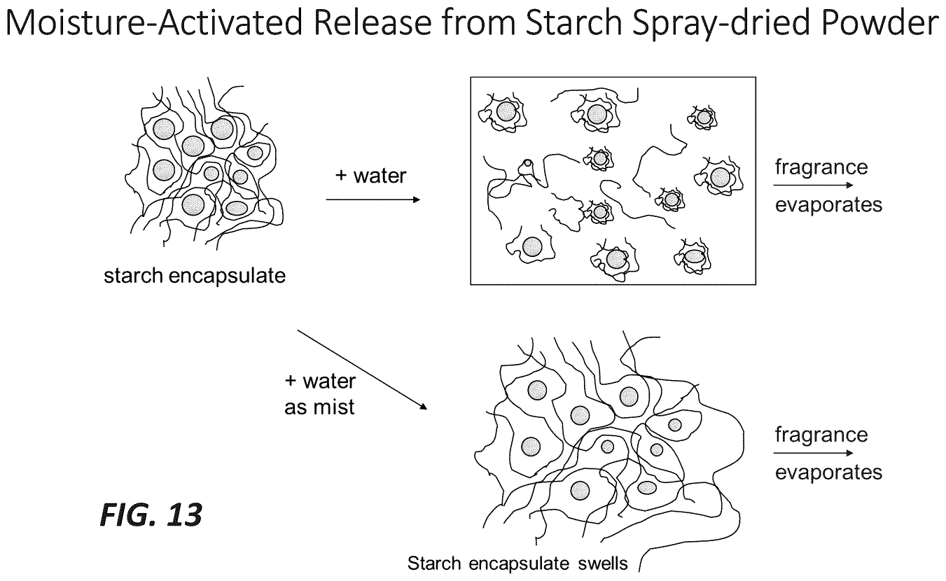

FIG. 13 is a schematic showing a process for moisture-activated release from starch spray-dried powder.

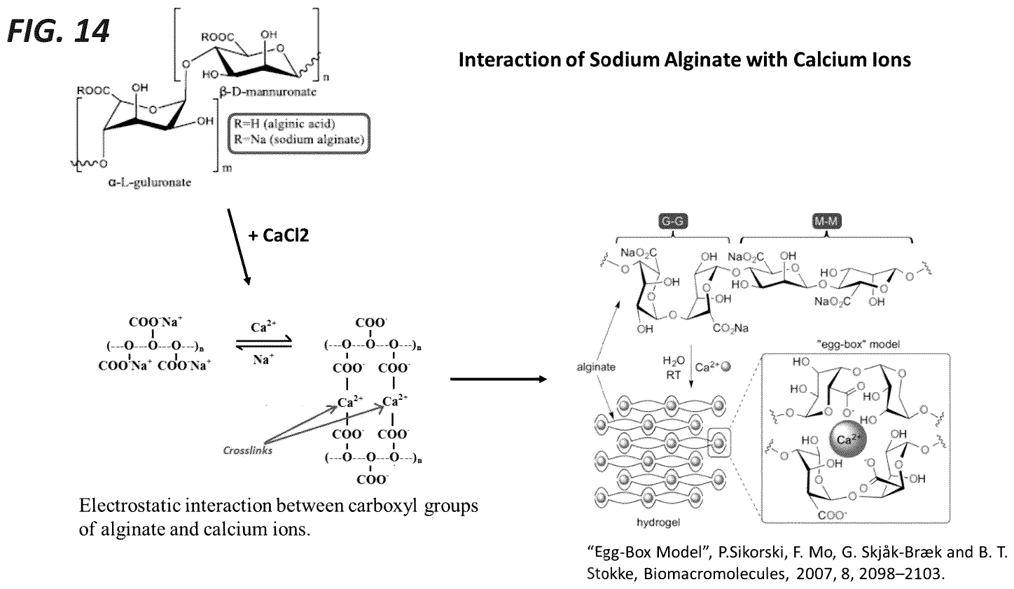

FIG. 14 is a schematic showing contemplated interaction of sodium alginate with calcium ions.

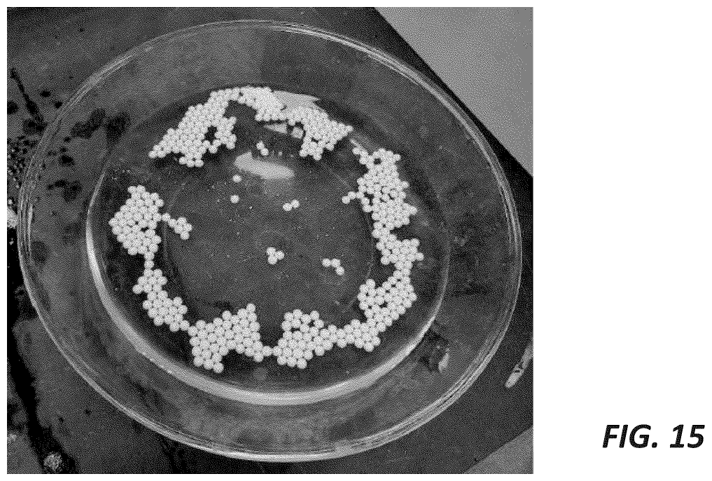

FIG. 15 depicts a collection of beads of the inventive subject matter.

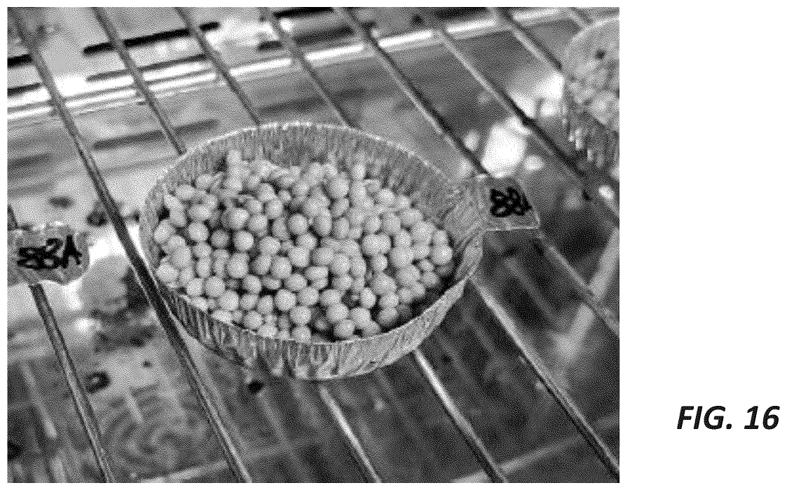

FIG. 16 depicts beads prepared using the inventive subject matter.

### EXAMPLE 1

### Making of the Beads

Further methods of creating beads are contemplated. First, create an alginate solution by dissolving sodium alginate in distilled water. Then, add chitosan or surfactant to the solution. Next, add orange oil or oil-plated carrier and mix the contents vigorously. In case of emulsions, use sonic energy or vibration (e.g., horn) to minimize droplet size. Next drip the emulsion or slurry into a calcium bath using a pipette to form beads. Dry the beads in an oven overnight at 60 C.

The following Table 1 includes sample formulations of oil-loaded/coated beads:

TABLE 1

| Sample | 79A | 79B | 88A | 88C |
|---|---|---|---|---|
| Alginate | 6.0% | 2.9% | 6.3% | 6.3% |
| Tween | 4.5% | 4.3% | — | |
| Oil | 89.5% | 87.0% | 31.3% | 18.8% |
| Chitosan | — | 5.8% | — | |
| Nusorp | — | — | 62.5% | 75.0% |
| Starch | — | — | — | |
| Total: | 100% | 100% | 100% | 100% |

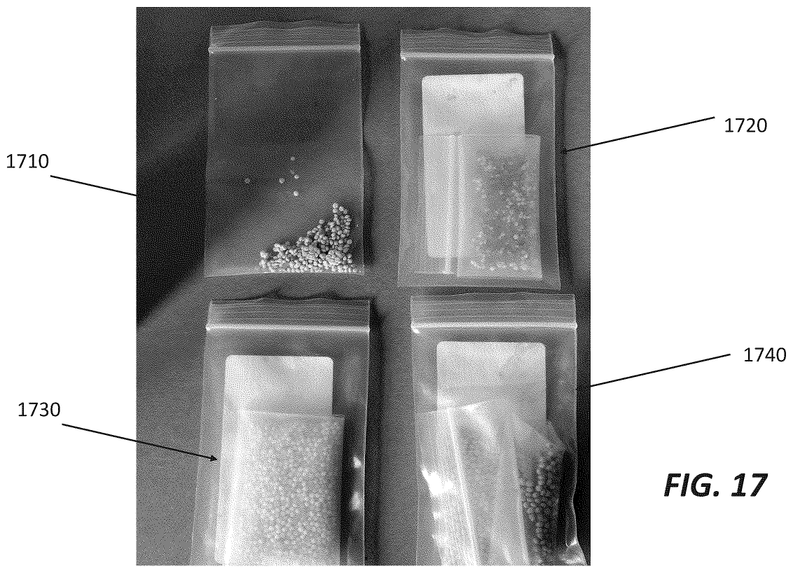

FIG. 17 depicts further beads of the inventive subject matter, including batches 1710, 1720, 1730, and 1740. Note the variety of sizes of the beads (e.g., diameter between 0.1 mm to 3 mm, in some cases between 3 mm to 5 mm), and the generally globular shape. It is contemplated that batches having different properties (e.g., batch with consistent diameter, shape, amount of oil coated/loaded, etc.) can be used for different applications (e.g., potted plant, ground planted, aesthetic plant, flowered plant, food-source plant, ground cover, grass, etc.). In some cases, batches of beads having different properties can be mixed together to provide a diverse bead profile with unexpectedly favorable results (e.g., improved nutrient delivery, improved odor, improved plant growth, etc.).

### EXAMPLE 2

### Performance of the Beads

| | | | In-Ground |
|---|---|---|---|
| | Dry Odor | In-Ground Odor | Odor Intensity |
| Sample | Intensity | Intensity Dry | Wetted |
| 79A | 2 | 2 | 3 |
| 79B | 2 | 2 | 3 |
| 88A | 1 | 1 | 2 |
| 88C | 1 | 1 | 2 |

An example process is to put soil into a container and place beads on top of the soil. Wet the soil and beads (e.g., spray bottle, less than between 1 mL to 5 mL watter, etc.). Let rest 10 minutes after wetting before smelling. Odor intensity using the following scale: 0 no odor (e.g., undetectable to average human at less than 6, 5, 4, 3, 2, or 1 inch distance), 1 weak odor (e.g., undetectable to average human at between 1 to 5 feet distance), 2 moderate odor (e.g., undetectable to average human at between 6 to 15 feet distance), 3 strong odor (e.g., undetectable to average human at between 15 to 50 feet or more than 50 feet distance). Other odor metrics can be used where appropriate, for example as published in ASTM E679 and E544, or proposed European Normalization Standard prEN 13725, which are incorporated herein by reference.

Ranges expressed herein include all intermediate ranges, each intermediate value in the range, and the endpoints.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A composition of matter, comprising:
a plant-usable nutrient derived from a first source;
an odiferous compound obtained from a second source different from the first source; and
a water-dissolvable carrier that carries the plant-usable nutrient and the odiferous compound.

2. The composition of claim 1, wherein the odiferous compound comprises a pleasant fragrance or fragrance containing one or more precursors/profragrances.

3. The composition of claim 2, wherein the odiferous compound comprises a combination of a fragrance oil and a microencapsulated fragrance oil.

4. The composition of claim 1, wherein the carrier comprises a water-dissolvable polymer, comprising a calcium-crosslinked coacervated bead composed of sodium alginate or alginic acid and chitosan.

5. The composition of claim 1, wherein the carrier comprises a water-dissolvable polymer, comprising a tripoly-phosphate-crosslinked coacervated bead composed of sodium alginate or alginic acid and chitosan.

6. The composition of claim 1, wherein the carrier comprises a water-dissolvable polymer, comprising a mixture of calcium-and tripoly-phosphate-crosslinked coacervated bead composed of sodium alginate or alginic acid and chitosan.

7. The composition of claim 1, wherein the carrier comprises a water-dissolvable polymer, comprising a calcium-crosslinked coacervated bead composed of sodium alginate or alginic acid and protein or hydrolyzed protein.

8. The composition of claim 1, wherein the carrier comprises a water-dissolvable polymer, comprising a tripoly-phosphate-crosslinked coacervated bead composed of sodium alginate or alginic acid and protein or hydrolyzed protein.

9. The composition of claim 1, wherein the carrier comprises a water-dissolvable polymer, comprising a mixture of calcium-and tripoly-phosphate-crosslinked coacervated bead composed of sodium alginate or alginic acid and protein or hydrolyzed protein.

10. The composition of claim 7, wherein the protein or hydrolyzed protein is based on pea protein, gelatin, collagen, silk protein or other proteins, and mixtures thereof.

11. The composition of claim 4, wherein the sodium alginate or alginic acid is replaced by other natively charge polysaccharides such as sodium carboxy methyl cellulose, carrageenan, pectin, xanthan gum, and gum arabic.

12. The composition of claim 1, wherein the carrier has the shape of a stick, a bead, or a tablet.

13. The composition of claim 12, wherein the shaped carrier has an additional chitosan or protein coating.

14. The composition of claim 12, wherein the shaped carrier is blended with a flow agent like starch or silica and subsequently dried.

15. The composition of claim 4, wherein the chitosan has a molecular weight from about 50,000 to 500,000 Daltons.
